(19) United States
(12) Patent Application Publication
(10) Pub. No.: US 2025/0386303 A1
(43) Pub. Date: Dec. 18, 2025

(54) METHOD, DEVICE AND COMPUTER STORAGE MEDIUM OF COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/728,690

(22) PCT Filed: Jan. 14, 2022
(86) PCT No.: PCT/CN2022/072115

§ 371 Date: Jul. 12, 2024

(51) Int. Cl. H04W 52/26

(52) U.S. Cl. CPC H04W 52/262

(57) ABSTRACT

Embodiments of the present disclosure relate to methods, devices and computer readable media for communication. A terminal device generates a PHR for a first waveform based on at least one of a MCS or a scheduled bandwidth for an uplink transmission, the uplink transmission being performed by using a second waveform different from the first waveform; and transmits the PHR to a network device. In this way, a PHR for an unused waveform may be reported.

### TECHNICAL FIELD

Embodiments of the present disclosure generally relate to the field of telecommunication, and in particular, to methods, devices and computer storage media of communication for power headroom report (PHR).

### BACKGROUND

Currently, a waveform for an uplink (UL) transmission is semi-statically configured by a radio resource control (RRC) signaling to be orthogonal frequency division multiplexing (OFDM) or discrete Fourier transform-spread-OFDM (DFT-s-OFDM) waveform. Technically, a DFT-s-OFDM waveform has a lower peak to average power ratio (PAPR) than an OFDM waveform, and thus can support higher transmit power. However, a DFT-s-OFDM waveform has relatively lower spectrum efficiency than an OFDM waveform due to poorer frequency selective gain and only single layer transmission.

Recently, it is agreed that a dynamic waveform switching should be studied for coverage enhancement. That is, the waveform for the UL transmission may be switched from an OFDM waveform to a DFT-s-OFDM waveform or from a DFT-s-OFDM waveform to an OFDM waveform by a lower layer signaling. Due to different maximum transmit power for DFT-s-OFDM and OFDM waveforms, an enhancement of PHR reporting needs to be considered to better support the dynamic waveform switching.

### SUMMARY

In general, embodiments of the present disclosure provide methods, devices and computer storage media of communication for PHR reporting.

In a first aspect, there is provided a method of communication. The method comprises: generating, at a terminal device, a PHR for a first waveform based on at least one of a modulation and coding scheme (MCS) or a scheduled bandwidth for an uplink transmission, the uplink transmission being performed by using a second waveform different from the first waveform; and transmitting the PHR to a network device.

In a second aspect, there is provided a method of communication. The method comprises: transmitting, at a terminal device and to a network device, a PHR for a first waveform unused by an uplink transmission, in response to at least one of the following: receiving, from the network device, first downlink control information (DCI) indicating the transmission of the PHR; a variation of a power parameter being above or below a threshold variation; a value of the PHR being above or below a threshold value; a measured rank indicator (RI) changing from a first number to a second number; or a modulation order indicated by second DCI being different from a modulation order indicated by third DCI earlier than the second DCI.

In a third aspect, there is provided a method of communication. The method comprises: receiving, at a network device and from a terminal device, a PHR for a first waveform, the PHR being generated by the terminal device based on at least one of a MCS or a scheduled bandwidth for an uplink transmission, the uplink transmission being performed by using a second waveform different from the first waveform.

In a fourth aspect, there is provided a method of communication. The method comprises: transmitting, at a network device and to a terminal device, first DCI indicating transmission of a PHR for a first waveform unused by an uplink transmission; and receiving the PHR from the terminal device.

In a fifth aspect, there is provided a device of communication. The device comprises a processor configured to perform the method according to any of the first and third aspects of the present disclosure.

In a sixth aspect, there is provided a device of communication. The device comprises a processor configured to perform the method according to any of the second and fourth aspects of the present disclosure.

In a seventh aspect, there is provided a computer readable medium having instructions stored thereon. The instructions, when executed on at least one processor, cause the at least one processor to perform the method according to any of the first and third aspects of the present disclosure.

In an eighth aspect, there is provided a computer readable medium having instructions stored thereon. The instructions, when executed on at least one processor, cause the at least one processor to perform the method according to any of the second and fourth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of communication according to embodiments of the present disclosure;

FIG. 3A illustrates a schematic diagram illustrating an example determination of a scheduled bandwidth for an unused waveform according to embodiments of the present disclosure;

FIG. 3B illustrates a schematic diagram illustrating another example determination of a scheduled bandwidth for an unused waveform according to embodiments of the present disclosure;

FIG. 3C illustrates a schematic diagram illustrating still another example determination of a scheduled bandwidth for an unused waveform according to embodiments of the present disclosure;

FIG. 3D illustrates a schematic diagram illustrating yet another example determination of a scheduled bandwidth for an unused waveform according to embodiments of the present disclosure;

FIG. 3E illustrates a schematic diagram illustrating an example medium access control (MAC) control element (CE) for PHR reporting according to embodiments of the present disclosure;

FIG. 3F illustrates a schematic diagram illustrating another example MAC CE for PHR reporting according to embodiments of the present disclosure;

FIG. 4 illustrates a schematic diagram illustrating another process of communication according to embodiments of the present disclosure;

FIG. 5 illustrates a schematic diagram illustrating an example PHR reporting for an unused waveform according to embodiments of the present disclosure;

FIG. 6 illustrates an example method of communication implemented at a terminal device in accordance with some embodiments of the present disclosure;

FIG. 7 illustrates another example method of communication implemented at a terminal device in accordance with some embodiments of the present disclosure;

FIG. 8 illustrates an example method of communication implemented at a network device in accordance with some embodiments of the present disclosure;

FIG. 9 illustrates another example method of communication implemented at a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and play back appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best, “lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As known, a PHR is used to enable power-aware scheduling for UL. With the knowledge of PHR, a network device may determine the number of scheduled physical resource blocks (PRBs) and/or MCS for the next UL transmission.

For coverage enhancement, a dynamic waveform switching between OFDM and DFT-s-OFDM waveforms will be supported. It means that a network device may dynamically indicate a terminal device to switch a waveform for a particular UL transmission, for example, by DCI. Typically, a DFT-s-OFDM waveform may be used in a cell edge due to higher transmit power and an OFDM waveform may be used in cell center due to higher spectrum efficiency. However, it is not mandatory, i. e., the DFT-s-OFDM waveform may also be used in cell center.

The dynamic waveform switching may occur more frequently than the current semi-static configuration of a waveform. However, the difference between the maximum transmit power for OFDM and DFT-s-OFDM waveforms may be considerable, especially for the lower modulation order, e.g., when pi/2 binary phase shift keying (BPSK) with power boosting is supported.

Thus, if a network device decides to switch a waveform for an UL transmission, the network device does not know the maximum transmit power for an unused waveform. In this case, the network device may make a wrong decision on the number of scheduling PRBs. Thus, waveform-specific PHR is beneficial for a scheduling in the dynamic waveform switching scenario. However, it may be unnecessary for a terminal device to always report two PHRs for two waveforms as the report may cause high overhead, especially in the case that a channel status changes slowly.

Embodiments of the present disclosure provide a solution of PHR reporting for an unused waveform. In one aspect, a terminal device generates a PHR for a first waveform based on at least one of a MCS or a scheduled bandwidth for an UL transmission performed with a second waveform, and transmits the PHR to a network device.

In this way, a network device may obtain power headroom for two different waveforms, and thereby determine whether to perform a waveform switching based on the power headroom for the two different waveforms. Once the network device decides to perform the waveform switching, with the knowledge of PHR for the unused waveform, the network device may determine the number of scheduled PRBs and MCS for the UL transmissions after the waveform is switched more accurately.

In another aspect, a terminal device transmits a PHR for a first waveform unused by an uplink transmission in response to at least one of the following: receiving, from the network device, first DCI indicating the transmission of the PHR; a variation of a power parameter being above or below a threshold variation; a value of the power parameter being above or below a threshold value; a measured RI changing from a first number to a second number; or a modulation order indicated by second DCI being different from a modulation order indicated by third DCI earlier than the second DCI. In this way, a PHR for the unused waveform is reported only if necessary and thus signaling overhead may be saved.

Embodiments of the present disclosure may be applied to any suitable scenarios. For example, embodiments of the present disclosure may be implemented for XR. Alternatively, embodiments of the present disclosure can be implemented in one of the followings: reduced capability NR devices, NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

Principles and implementations of the present disclosure will be described in detail below with reference to the figures.

### Example of Communication Network

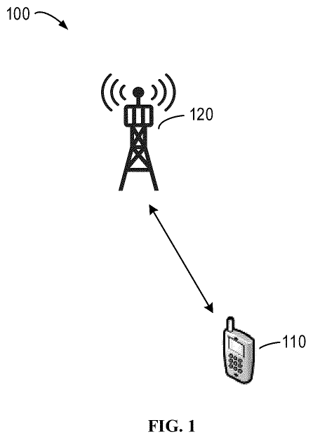

FIG. 1 illustrates a schematic diagram of an example communication network 100A in which some embodiments of the present disclosure can be implemented. As shown in FIG. 1, the communication network 100 may include a terminal device 110 and a network device 120. In some embodiments, the terminal device 110 may be served by the network device 120. It is to be understood that the numbers of terminal devices and network devices in FIG. 1 are given for the purpose of illustration without suggesting any limitations to the present disclosure. The communication network 100 may include any suitable number of network devices and/or terminal devices adapted for implementing implementations of the present disclosure.

As shown in FIG. 1, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the network device 120 may transmit, to the terminal device 110, an indication indicating a waveform switching for an UL transmission. In this way, a dynamic waveform switching is triggered. In some embodiments, the indication may be carried in DCI. Of course, any other suitable ways are also feasible for the indication. In some embodiments, when an OFDM waveform is used, a transform precoding is disabled. When a DFT-s-OFDM waveform is used, the transform precoding is enabled. Technically, the transform precoding is a DFT processing.

In some embodiments, the terminal device 110 may transmit a PHR to the network device 120. In some embodiments, transmit power of an UL transmission may be determined mainly based on the following factors: a configured maximum output power (denoted as P_{CMAX}) which is mainly dependent on the waveform and modulation order; an open loop parameter (denoted as P_{O}) which reflects an expected receive power by a network device; path loss (denoted as PL) and the compensation factor (denoted as α); MCS factor (denoted as Δ_{TF}) which is dependent on bits per resource element (RE) (BPRE); a close loop adjustment value f which is indicated by a network device in DCI and can be accumulated. For example, if a UE transmits a PUSCH on active UL BWP b of carrier f of serving cell C using parameter set configuration with index j and PUSCH power control adjustment state with index 1, the UE determines the PUSCH transmission power P_{PUSCH,b,f,c} (i, j,q_{d},l) in PUSCH transmission occasion i as shown by equation (1) below.

$${P}_{PUSCH . b , f , c} ( i , j , {q}_{d} , l ) = min \{ \begin{matrix}{P}_{CMAX , f , c ( i ) ,} \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot \\ {PL}_{b , f , c} ( {q}_{d} ) + {Δ}_{TF , b , f , c} ( i ) + {f}_{b , f , c} ( i , l )\end{matrix} \}\end{matrix} \qquad ( 1 )$$

where P_{CMAX,f,c} (i) is the UE configured maximum output power for carrier f of serving cell c in PUSCH transmission occasion i.

The UE is allowed to set its configured maximum output power P_{CMAX,f,c} for carrier f of serving cell c in each slot. The configured maximum output power P_{CMAX,f,c} is set within the following bounds as shown in equation (2) below.

$${P}_{CMAX \_ L , f , c ,} \leq {P}_{CMAX , f , c} \leq {P}_{CMAX \_ H , f , c} \qquad ( 2 )$$

where P_{CMAX_L,f,c} and P_{CMAX_H,f,c} are defined as shown in equation (3) and (4) below.

$${P}_{CMAX \_ L , f , c} = MIN \{ {P}_{EMAX , c} - {Δ}_{TC , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \} \qquad ( 3 )$$

$${P}_{CMAX \_ H , f , c} = \{ {P}_{EMAX , c} , {P}_{PowerClass} - Δ {P}_{PowerClass} \} \qquad ( 4 )$$

Three types of PHR are supported in new radio (NR). Type 1 PHR is based on an UL transmission such as a physical uplink shared channel (PUSCH) transmission. Type 2 PHR can be used in EUTRA-NR dual connection (EN-DC) scenario. Type 3 PHR is based on a sounding reference signal (SRS) transmission.

In some embodiments for Type 1 PHR, power headroom (PH) may be determined based on actual UL transmission. In some embodiments, the PH may equal to the difference between a configured maximum output power and an estimated power of the actual UL transmission. For example, If a UE determines that a Type 1 PHR for an activated serving cell is based on an actual PUSCH transmission then, for PUSCH transmission occasion i on active UL BWP b of carrier f of serving cell c, the UE computes the Type 1 PHR as shown in equation (5) below.

$${PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} \qquad ( 5 )$$

It should be noted that the difference between two P_{CMAX} or two PH for the two waveforms may be considerable, especially for the lower modulation order, e.g., when pi/2 BPSK with power boosting is supported. The value of P_{CMAX} depends on UE implementation and it is not a constant. Thus, when a network device decides to switch a waveform for PUSCH, the network device does not know the P_{CMAX} or PH for the unused waveform. In this case, the network device may make a wrong decision on the number of scheduling PRBs after the waveform is switched. Thus, waveform-specific PHR is beneficial for a scheduling in the dynamic waveform switching scenario. However, it may be unnecessary for a terminal device to always report two PHRs for two waveforms as the report may cause high overhead, especially in the case that a channel status changes slowly. Thus, the PHR for the unused waveform may be triggered on-demand.

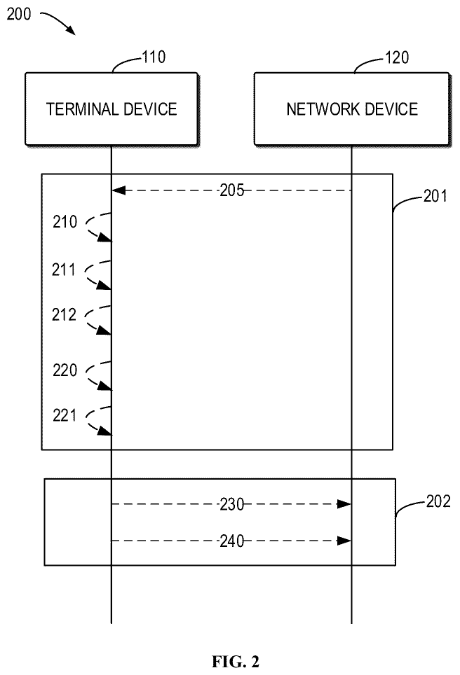

Embodiments of the present disclosure provide solutions of PHR reporting for an unused waveform. The solutions will be described below with reference to FIGS. 2 to 5.

### Example Implementation of PHR Reporting for Unused Waveform

In one aspect, embodiments of the present disclosure provide a solution for reporting a PHR for an unused waveform. FIG. 2 illustrates a schematic diagram illustrating a process 200 of communication according to embodiments of the present disclosure. For the purpose of discussion, the process 200 will be described with reference to FIG. 1. The process 200 may involve the terminal device 110 and the network device 120 as illustrated in FIG. 1.

As shown in FIG. 2, the terminal device 110 generates 201 a PHR for a waveform (for convenience, also referred to as a first waveform or an unused waveform herein) unused by an UL transmission based on at least one of a MCS or a scheduled bandwidth for the UL transmission. The UL transmission is performed by using another waveform (for convenience, also referred to as a second waveform or a used waveform herein). In some embodiments, the first waveform may be an OFDM waveform, and the second waveform may be a DFT-s-OFDM waveform. In some alternative embodiments, the first waveform may be a DFT-s-OFDM waveform, and the second waveform may be an OFDM waveform.

According to embodiments of the present disclosure, the PHR for the unused waveform may be determined based on a reference UL transmission with an assumption that the used waveform of an actual UL transmission is replaced by the unused waveform and some possible modification of the MCS and scheduled bandwidth is made. Some example embodiments of a PHR generation will be described in connection with Embodiments 1 and 2.

### Embodiment 1

In this embodiment, the terminal device 110 may generate the PHR for the unused waveform based on the MCS for the UL transmission.

Still with reference to FIG. 2, the network device 120 may transmit 205, to the terminal device 110, a configuration indicating a MCS table (for convenience, also referred to as a first MCS table herein) for the first waveform and a MCS table (for convenience, also referred to as a second MCS table herein) for the second waveform. For illustration, examples of the MCS tables are shown in Tables 1 and 2 below.

TABLE 1
An Example of MCS Table for PUSCH

| MCS Index | Modulation Order | Target code Rate | Spectral |
|---|---|---|---|
| I_{MCS} | Qₘ | R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

TABLE 2
An Example of MCS Table for PUSCH
with Transform Precoding and 64QAM

| MCS Index | Modulation Order | Target code Rate | Spectral |
|---|---|---|---|
| I_{MCS} | Qₘ | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

In the example of Table 2, if higher layer parameter tp-pi2BPSK is configured, q=1; otherwise q=2. It is to be understood that the above tables are merely examples, and do not make limitation for the present disclosure.

In some embodiments for PHR determination, the terminal device 110 may determine 210 a MCS index (for convenience, also referred to as a first MCS index herein) in the first MCS table based on a MCS index (for convenience, also referred to as a second MCS index herein) in the second MCS table used by the UL transmission. Then the terminal device 110 may determine 211 a modulation order (for convenience, also referred to as a first modulation order herein) for the first waveform and a modulation order (for convenience, also referred to as a second modulation order herein) for the second waveform based on the first MCS index and the second MCS index, and determine 212 the PHR based on the first modulation order and the second modulation order.

In some embodiments for determination of the first MCS index, the terminal device 110 may determine the first MCS index as being equal to the second MCS index. Accordingly, the first modulation order and the second modulation order may be determined. In these embodiments, if the first modulation order is the same as the second modulation order, the terminal device 110 may determine the PHR based on the first modulation order or the second modulation order. If the first modulation order is different from the second modulation order, the terminal device 110 may determine the PHR by using a predetermined modulation order.

The predetermined modulation order may be determined based on a type of the second waveform (i.e., the used waveform) and a type of the second modulation order. For example, if the used waveform is a DFT-s-OFDM waveform and the corresponding MCS index is associated with pi/2 BPSK, the PHR for the unused waveform may be determined based on quadrature phase shift keying (QPSK). As another example, if the used waveform is an OFDM waveform, the corresponding MCS index is associated with QPSK in the MCS table for the used waveform but is associated with pi/2 BPSK in the MCS table for the unused waveform, the PHR for the unused waveform may be determined based on pi/2 BPSK. As still another example, if the used waveform is an OFDM waveform, the corresponding MCS index is associated with 256QAM/512QAM in the MCS table for the used waveform but 256QAM/512QAM is not supported for the unused waveform, the PHR for the unused waveform may be determined based on 64QAM.

For illustration, some examples will be described in connection with the above Tables 1 and 2. Assuming that the first waveform (i.e., the unused waveform) is a DFT-s-OFDM waveform and the second waveform (i.e., the used waveform) is an OFDM waveform. The above Table 1 is for OFDM and Table 2 is for DFT-s-OFDM. In an example, assuming that a MCS index (i.e., the second MCS index) used by the UL transmission is 3. Then, a MCS index (i.e., the first MCS index) for the unused waveform is also 3. It can be known from Table 1 that a modulation order (i.e., the second modulation order) corresponding to the MCS index 3 for OFDM is 2. It can be known from Table 2 that a modulation order (i.e., the first modulation order) corresponding to the MCS index 3 for DFT-s-OFDM is 2. In this example, the first modulation order is the same as the second modulation order, and thus the terminal device 110 may determine the PHR based on the first modulation order or the second modulation order being 2. For example, the terminal device 110 may determine at least one of P_{CMAX} or PH as the PHR, for example, by the above equations (1) to (5).

In another example, assuming that a MCS index (i.e., the second MCS index) used by the UL transmission is 0. Then, a MCS index (i.e., the first MCS index) for the unused waveform is also 0. It can be known from Table 1 that a modulation order (i.e., the second modulation order) corresponding to the MCS index 0 for OFDM is 2. It can be known from Table 2 that a modulation order (i.e., the first modulation order) corresponding to the MCS index 0 for DFT-s-OFDM is q. In this example, the first modulation order is different from the second modulation order. Assuming that the higher layer parameter tp-pi2BPSK is configured, then q=1. In this case, the MCS index 0 is associated with QPSK in Table 1 but is associated with pi/2 BPSK in Table 2. Thus, the terminal device 110 may determine pi/2 BPSK as the predetermined modulation order and determine the PHR by using pi/2 BPSK. For example, the terminal device 110 may determine at least one of P_{CMAX} or PH as the PHR, for example, by the above equations (1) to (5).

In some alternative embodiments for determination of the first MCS index, the terminal device 110 may determine the first MCS index so that a spectral efficiency (for convenience, also referred to as a first spectral efficiency herein) associated with the first MCS index is the closest spectral efficiency in the first MCS table to a spectral efficiency (for convenience, also referred to as a second spectral efficiency herein) associated with the second MCS index. In some embodiments, the first spectral efficiency may be not smaller than the second spectral efficiency. In some embodiments, the first spectral efficiency may be not higher than the second spectral efficiency. Upon determination of the first MCS index and the second MCS index, the first modulation order and the second modulation order may be determined accordingly. In these embodiments, if the first modulation order is the same as the second modulation order, the terminal device 110 may determine the PHR based on the first modulation order or the second modulation order.

For illustration, an example will be described in connection with Tables 3 and 4. Assuming that the first and second MCS tables may be configured as shown in Tables 3 and 4 below.

TABLE 3
Another Example of MCS Table for PUSCH

| MCS Index | Modulation Order | Target code Rate | Spectral |
|---|---|---|---|
| I_{MCS} | Qₘ | R × [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |
| 31 | 8 | reserved |

TABLE 4
Another Example of MCS Table for PUSCH
with Transform Precoding and 64QAM

| MCS Index | Modulation Order | Target code Rate | Spectral |
|---|---|---|---|
| I_{MCS} | Qₘ | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

In the example of Table 4, if higher layer parameter tp-pi2BPSK is configured, q=1; otherwise q=2. It is to be understood that the above tables are merely examples, and do not make limitation for the present disclosure.

Assuming that the first waveform (i.e., the unused waveform) is an OFDM waveform and the second waveform (i.e., the used waveform) is a DFT-s-OFDM waveform. The above Table 3 is for OFDM and Table 4 is for DFT-s-OFDM. Assuming that a MCS index (i.e., the second MCS index) used by the UL transmission is 3. It can be known from Table 4 that the spectral efficiency (i.e., the second spectral efficiency) corresponding to the MCS index 3 for DFT-s-OFDM is 0.4902. It can be known from Table 3 that the spectral efficiency (i.e., the first spectral efficiency) for OFDM closest to but not larger than 0.4902 is 0.3770 corresponding to the MCS index 1. Thus, a MCS index (i.e., the first MCS index) for the unused waveform is determined as the MCS index 1. In this case, it can be known from Table 3 that the first modulation order corresponding to the MCS index 1 for DFT-s-OFDM is 2, and it can be known from Table 4 that the second modulation order corresponding to the MCS index 3 for OFDM is 2. As the first modulation order is the same as the second modulation order, the terminal device 110 may determine the PHR based on the first modulation order or the second modulation order. For example, the terminal device 110 may determine at least one of P_{CMAX} or PH as the PHR, for example, by the above equations (1) to (5).

In some embodiments, if the first modulation order is different from the second modulation order, the terminal device 110 may determine the PHR based on the first modulation order (i.e., the modulation order associated with the MCS index in the MCS table for the unused waveform). In some embodiments, if the first modulation order is different from the second modulation order, the terminal device 110 may determine the PHR based on a lower one of the first and second modulation orders. In some embodiments, if the first modulation order is different from the second modulation order, the terminal device 110 may determine the PHR based on a higher one of the first and second modulation orders. In some embodiments, if the first modulation order is different from the second modulation order, the terminal device 110 may determine the PHR based on a configuration from the network device 120, the configuration indicating whether the first or second modulation order is used for the determination of the PHR.

In some alternative embodiments for PHR determination, the terminal device 110 may directly determine the first modulation order for the first waveform as being equal to the second modulation order associated with the second MCS index in the second MCS table for the second waveform, and determine the PHR based on the PHR based on the first modulation order. It is to be understood that the above examples are merely for illustration, and are not intended for limitation.

### Embodiment 2

In this embodiment, the terminal device 110 may generate the PHR for the unused waveform based on the scheduled bandwidth for the UL transmission. In some embodiments, the terminal device 110 may generate the PHR for the unused waveform based on the number of physical resource blocks (PRBs) for the UL transmission.

Still with reference to FIG. 2, the terminal device 110 may determine 220 a set of PRBs (for convenience, also referred to as a first set of PRBs herein) for the first waveform (i.e., the unused waveform) at least based on a set of PRBs (for convenience, also referred to as a second set of PRBs herein) for the second waveform (i.e., the used waveform).

In some embodiments, the terminal device 110 may determine the first set of PRBs so that the number of PRBs in the first set of PRBs is an integer which is closest to the number of PRBs in the second set of PRBs. For example, the integer may be the largest integer which is not larger than the number of PRBs in the second set of PRBs. As another example, the integer may be the smallest integer which is not smaller than the number of PRBs in the second set of PRBs. In these embodiments, the integer also satisfies a requirement on an allowed PRB number

$${M}_{RB}^{PUSCH}$$

as shown in equation (6) below.

$${M}_{RB}^{PUSCH} = {2}^{a 2} * {3}^{a 3} * {5}^{a 5} \qquad ( 6 )$$

where a2, a3 and a5 are non-negative integers.

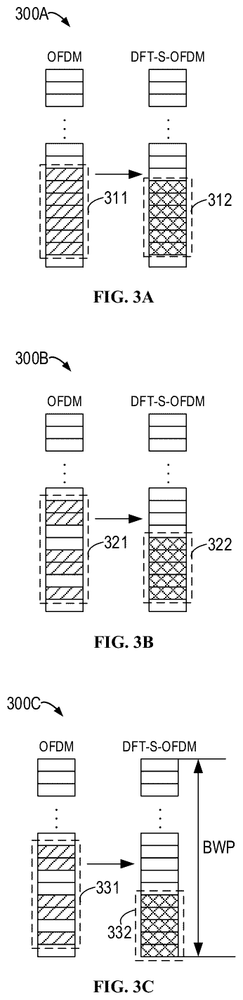

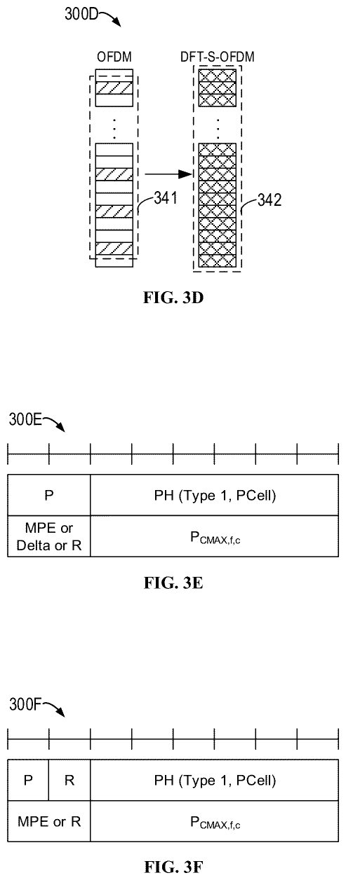

For illustration, an example will be described in connection with FIG. 3A. FIG. 3A illustrates a schematic diagram 300 A illustrating an example determination of a scheduled bandwidth for an unused waveform according to embodiments of the present disclosure. Assuming that the unused waveform is a DFT-s-OFDM waveform and the used waveform is an OFDM waveform. As shown in FIG. 3A, a set of PRBs 311 is used for UL transmission with the OFDM waveform. Based on the set of PRBs 311, a set of PRBs 312 may be determined for the DFT-s-OFDM waveform. In this example, the number of PRBs in the set of PRBs 312 is the largest integer which is not larger than the number of PRBs in the set of PRBs 311. It is to be understood that this is merely an example and does not make limitation for the present disclosure.

In some embodiments where the second set of PRBs for the used waveform is non-contiguous, assuming that the first set of PRBs for the unused waveform is contiguous, the terminal device 110 may determine the first set of PRBs so that the first set of PRBs is contiguous and a PRB (for convenience, also referred to a first PRB herein) in the first set of PRBs is the same as a PRB (for convenience, also referred to a second PRB herein) in the second set of PRBs. For example, the terminal device 110 may determine the first set of PRBs so that the first PRB of the first set of PRBs in a frequency order may be the same as the first PRB of the second set of PRBs in a frequency order. As another example, the terminal device 110 may determine the first set of PRBs so that the last PRB of the first set of PRBs may be the same as the last PRB of the second set of PRBs.

For illustration, an example will be described in connection with FIG. 3B. FIG. 3B illustrates a schematic diagram 300B illustrating another example determination of a scheduled bandwidth for an unused waveform according to embodiments of the present disclosure. Assuming that the unused waveform is a DFT-s-OFDM waveform and the used waveform is an OFDM waveform. As shown in FIG. 3B, a set of PRBs 321 for OFDM is non-contiguous. Based on the set of PRBs 321, a set of PRBs 322 may be determined for the DFT-s-OFDM waveform. In this example, PRBs in the set of PRBs 322 are contiguous and the last PRB of the set of PRBs 322 is the same as the last PRB of the set of PRBs 321. It is to be understood that this is merely an example and does not make limitation for the present disclosure.

In some embodiments where the second set of PRBs for the used waveform is non-contiguous, the terminal device 110 may determine the first set of PRBs so that the first set of PRBs is contiguous and a PRB (for convenience, also referred to a third PRB herein) in the first set of PRBs is the same as a PRB (for convenience, also referred to a fourth PRB herein) in a predetermined bandwidth part (BWP). For example, the terminal device 110 may determine the first set of PRBs so that the first PRB of the first set of PRBs in a frequency order may be the same as the first PRB in the predetermined BWP in a frequency order. As another example, the terminal device 110 may determine the first set of PRBs so that the last PRB of the first set of PRBs may be the same as the last PRB in the predetermined BWP.

In some embodiments, the predetermined BWP may be the active BWP for the UL transmission. In some embodiments, the predetermined BWP may be preconfigured by the network device 120. In some embodiments, the predetermined BWP may be a preconfigured BWP for a preconfigured component carrier (CC). Of course, the predetermined BWP may also be determined in any other suitable ways.

For illustration, an example will be described in connection with FIG. 3C. FIG. 3C illustrates a schematic diagram 300C illustrating still another example determination of a scheduled bandwidth for an unused waveform according to embodiments of the present disclosure. Assuming that the unused waveform is a DFT-s-OFDM waveform and the used waveform is an OFDM waveform. As shown in FIG. 3C, a set of PRBs 331 for OFDM is non-contiguous. Based on the set of PRBs 331, a set of PRBs 332 may be determined for the DFT-s-OFDM waveform. In this example, PRBs in the set of PRBs 332 are contiguous and the last PRB of the set of PRBs 332 is the same as the last PRB in the predetermined BWP. It is to be understood that this is merely an example and does not make limitation for the present disclosure.

In some embodiments where the second set of PRBs for the used waveform is non-contiguous, the terminal device 110 may determine the first set of PRBs so that the first set of PRBs is the allowed maximum number of contiguous PRBs. In some embodiments, if frequency domain resource allocation type 2 is used (i.e., interlace based resource allocation is used), or if the terminal device 110 is working on the shared spectrum, the terminal device 110 may determine the PHR for the unused waveform based on an assumption that the maximum allowed number of contiguous PRBs are used. The allowed number of PRB may be determined based on the above equations (1) to (5) and a requirement of an occupied channel bandwidth (OCB), and may be configured by the network device 120.

For illustration, an example will be described in connection with FIG. 3D. FIG. 3D illustrates a schematic diagram 300D illustrating yet another example determination of a scheduled bandwidth for an unused waveform according to embodiments of the present disclosure. Assuming that the unused waveform is a DFT-s-OFDM waveform and the used waveform is an OFDM waveform. As shown in FIG. 3D, a set of PRBs 341 for OFDM is non-contiguous. Based on the set of PRBs 341, a set of PRBs 342 may be determined for the DFT-s-OFDM waveform. In this example, PRBs in the set of PRBs 342 are contiguous and occupy the whole BWP. It is to be understood that this is merely an example and does not make limitation for the present disclosure.

In some embodiments where the second set of PRBs for the used waveform is contiguous, the terminal device 110 may use the second set of PRBs as the first set of PRBs. In other words, if the resource allocation for the current UL transmission is always contiguous, the terminal device 110 may determine the PHR for the unused waveform based on the same resource allocation for the current UL transmission.

Return to FIG. 2, upon determination of the first set of PRBs, the terminal device 110 may determine 221 the PHR based on the number of PRBs in the first set of PRBs. In some embodiments, the terminal device 110 may determine at least one of P_{CMAX} or PH as the PHR, for example, by the equations (1) to (5).

It is to be understood that the above embodiments for determination the PHR for the unused waveform may be implemented in any suitable combination or separately.

Upon determination of the PHR for the unused waveform, the terminal device 110 transmits 202 the PHR for the unused waveform to the network device 120. In some embodiments for transmission of the PHR, the terminal device 110 may transmit 230 the PHR for the unused waveform together with a further PHR for the used waveform in a single MAC CE. For example, the PHR may comprise at least one of a P_{CMAX} value or a PH value for the unused waveform. As another example, the PHR may comprise a delta value determined based on a difference between the PHR for the unused waveform and the further PHR for the used waveform. For example, the delta value may comprise at least one of a delta PH or a delta P_{CMAX}.

In some embodiments, the MAC CE may comprise an indication (for convenience, also referred to as a first indication herein) indicating whether a maximum permissible exposure (MPE) or the delta value is reported. In this way, the MAC CE for PHR may be enhanced by reusing a field for MPE to report the delta value.

FIG. 3E illustrates a schematic diagram illustrating an example MAC CE 300E for PHR reporting according to embodiments of the present disclosure. As shown in FIG. 3E, the MAC CE 300E may comprise an indication P indicating whether the MPE or the delta value is reported. For example, if P equals to a first value, e.g., 10, then at least one of PH or P_{CMAX} is reported in the MAC CE 300E. If P equals to a second value, e.g., 01, then the delta value (denoted as Delta, i.e., at least one of delta PH or delta P_{CMAX}) is reported in the MAC CE 300E. It is to be understood that this is merely an example, and the MAC CE may adopt any other suitable forms.

In some alternative embodiments for transmission of the PHR, the terminal device 110 may transmit 240 the PHR for the unused waveform separately in a MAC CE. For example, when a trigger event occurs, the terminal device 110 may transmit 240 the PHR for the unused waveform. The MAC CE may comprise an indication (for convenience, also referred to as a second indication herein) indicating whether the PHR is based on the first waveform (i. e., the unused waveform) or the second waveform (i.e., the used waveform). For example, the MAC CE for PHR may be enhanced by reusing a field “R” for the second indication.

FIG. 3F illustrates a schematic diagram illustrating another example MAC CE 300F for PHR reporting according to embodiments of the present disclosure. As shown in FIG. 3F, the MAC CE 300F may comprise an indication P indicating whether the MPE is reported and a field R indicating whether the PHR is based on an unused waveform or a used waveform (i.e., the current waveform). For example, if R equals to 1, then the PHR for the unused waveform is reported in the MAC CE 300F. If R equals to 0, then the PHR for the used waveform is reported in the MAC CE 300F. It is to be understood that this is merely an example, and the MAC CE may adopt any other suitable forms.

So far, a PHR reporting for an unused waveform is described. In this way, a network device may obtain power headroom for two different waveforms, and thus may determine whether to perform a waveform switching based on the power headroom for the two different waveforms. Further, once the network device decides to perform the waveform switching, with the knowledge of PHR for the unused waveform, the network device may determine the number of scheduled PRBs and MCS for the next UL transmission more accurately.

### Example Implementation of Trigger of PHR Reporting for Unused Waveform

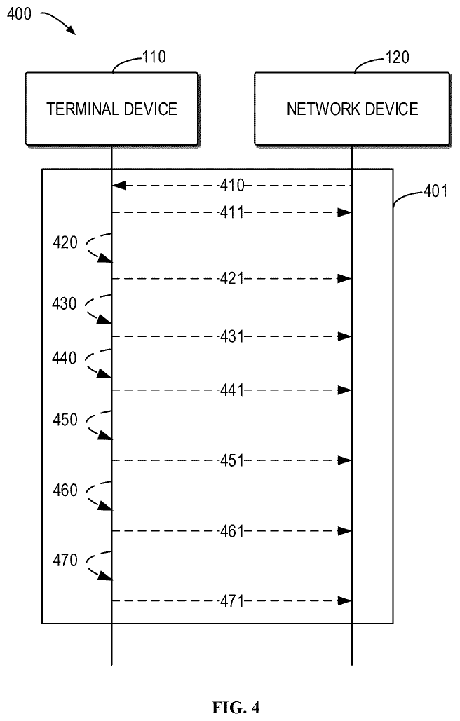

In another aspect, embodiments of the present disclosure provide a solution for triggering a PHR reporting for an unused waveform. FIG. 4 illustrates a schematic diagram illustrating another process 400 of communication according to embodiments of the present disclosure. For the purpose of discussion, the process 400 will be described with reference to FIG. 1. The process 400 may involve the terminal device 110 and the network device 120 as illustrated in FIG. 1.

As shown in FIG. 4, the terminal device 110 may report 401 a PHR for a waveform (i.e., the first waveform or the unused waveform) unused by an UL transmission in response to a trigger event.

In some embodiments, the terminal device 110 may receive 410, from the network device 120, DCI (for convenience, also referred to as first DCI herein) indicating transmission of PHR for the first waveform. In response to receiving the first DCI, the terminal device 110 may transmit 411 the PHR for the first waveform. In some embodiments, a field in the first DCI may indicate whether the PHR should be reported for the first waveform, a waveform (i.e., the second waveform or the used waveform) used by the uplink transmission, or both of the first and second waveforms.

In some embodiments, the field may comprise a PHR request field. For example, a PHR request field may be introduced in a DCI format 0_0, 0_1 or 0_2, e.g., a 1 bit or 2 bit PHR request. If the PHR request field indicates a first value (e.g., 0 or 00), the terminal device 110 may report the PHR for the second waveform in the next PHR reporting. If the PHR request field indicates a second value (e.g., 1 or 01), the terminal device 110 may report the PHR for the first waveform in the next PHR reporting. If the PHR request field indicates a third value (e.g., 10), the terminal device 110 may report PHRs for both the first and second waveforms in the next PHR reporting. It is to be understood that the first, second and third values may adopt any other suitable forms.

In some embodiments, the field may comprise a sounding reference signal (SRS) request field or a Transmit Power Control (TPC) command field. For example, a set of codepoints of the SRS request field or TPC command field are associated with the unused waveform, if the SRS requests field or TPC command field indicates one of the set of codepoints, then the terminal device 110 may report the PHR for the unused waveform in the next PHR reporting. The set of codepoints may comprise one or more codepoints.

The above description provides a PHR reporting explicitly triggered by DCI. Embodiments of the present disclosure also provide a PHR reporting triggered by occurrence of some events and satisfaction of some criteria. Some example embodiments will be described below.

In some embodiments, the terminal device 110 may determine 420 whether a delta value is above a threshold delta. The delta value is determined based on a difference between the PHR for the first waveform and a further PHR for a second waveform used by the uplink transmission. If the delta value is above the threshold delta, the terminal device 110 may transmit 421 the PHR for the first waveform. For example, the terminal device 110 may determine whether a delta PH is above a threshold delta PH. As another example, the terminal device 110 may determine whether a delta P_{CMAX} is above a threshold delta P_{CMAX}. As a further example, if the current waveform (i.e., the second waveform) is an OFDM waveform, and the delta value is above the threshold delta, the terminal device 110 may transmit the PHR for the unused waveform (i.e., the first waveform).

Alternatively, the terminal device 110 may determine 430 whether the delta value is below the threshold delta. If the delta value is below the threshold delta, the terminal device 110 may transmit 431 the PHR for the first waveform. For example, the terminal device 110 may determine whether the delta PH is below the threshold delta PH. As another example, the terminal device 110 may determine whether the delta P_{CMAX} is below the threshold delta P_{CMAX}. As a further example, if the current waveform (i.e., the second waveform) is a DFT-s-OFDM waveform, and the delta value is below the threshold delta, the terminal device 110 may transmit the PHR for the unused waveform (i.e., the first waveform).

In some embodiments, the terminal device 110 may determine 440 whether a value of the PHR is above a threshold value. In some embodiments, the PHR may be a PH value for the first waveform. In some embodiments, the PHR may be a P_{CMAX} value for the first waveform. If the value of the PHR is above the threshold value, the terminal device 110 may transmit 441 the PHR for the first waveform. For example, the terminal device 110 may determine whether a PH value for the first waveform is above a threshold PH. As another example, the terminal device 110 may determine whether a P_{CMAX} for the first waveform is above a threshold P_{CMAX}. As a further example, if the current waveform (i.e., the second waveform) is a DFT-s-OFDM waveform, and the value of the PHR is above the threshold value, the terminal device 110 may transmit the PHR for the unused waveform (i.e., the first waveform).

Alternatively, the terminal device 110 may determine 450 whether the value of the PHR is below the threshold value. If the value of the PHR is below the threshold value, the terminal device 110 may transmit 451 the PHR for the first waveform. For example, the terminal device 110 may determine whether a PH value for the first waveform is below a threshold PH. As another example, the terminal device 110 may determine whether a P_{CMAX} for the first waveform is below a threshold P_{CMAX}. As a further example, if the current waveform (i.e., the second waveform) is an OFDM waveform, and the value of the PHR is below the threshold value, the terminal device 110 may transmit the PHR for the unused waveform (i.e., the first waveform).

In some embodiments, the terminal device 110 may determine 460 whether a measured rank indicator (RI) changes from a number (for convenience, also referred to as a first number herein) to another number (for convenience, also referred to as a second number herein). If the measured RI changes from the first number to the second number, the terminal device 110 may transmit 461 the PHR for the first waveform. In some embodiments, if the measured RI changes and if the terminal device 110 works on an unpaired spectrum, the terminal device 110 may transmit 461 the PHR for the first waveform.

For example, if the current waveform (i.e., the second waveform) is an OFDM waveform, and the measured RI changes from a number above 1 to 1, the terminal device 110 may transmit the PHR for the unused waveform (i.e., the first waveform). As another example, if the current waveform (i.e., the second waveform) is an DFT-s-OFDM waveform, and the measured RI changes from 1 to a number above 1, the terminal device 110 may transmit the PHR for the unused waveform (i.e., the first waveform).

In some embodiments, the terminal device 110 may determine 470 whether a modulation order indicated by current DCI (for convenience, also referred to as second DCI herein) is different from a modulation order indicated by previous DCI (for convenience, also referred to as third DCI herein) earlier than the current DCI. For example, the terminal device 110 may determine whether a modulation order indicated by current DCI is different from a modulation order of the last one UL transmission (e.g., the last one dynamically scheduled UL transmission (not the configured grant UL transmission)). If the modulation order indicated by the second DCI is different from the modulation order indicated by the third DCI, the terminal device 110 may transmit 471 the PHR for the first waveform.

For example, if the current waveform (i.e., the second waveform) is an OFDM waveform, and the modulation order is changed from a higher order to a lower order, the terminal device 110 may transmit the PHR for the unused waveform (i.e., the first waveform). As another example, if the current waveform (i.e., the second waveform) is an DFT-s-OFDM waveform, and the modulation order is changed from a lower order to a higher order, the terminal device 110 may transmit the PHR for the unused waveform (i.e., the first waveform). It is to be understood that the above embodiments for a trigger event may be implemented in any suitable combination or separately.

In some embodiments, in response to one or more trigger events, the terminal device 110 may transmit the PHR for the unused waveform with the UL transmission in an occasion (for convenience, also referred to as a first occasion herein). In some alternative embodiments, the terminal device 110 may transmit the PHR for the unused waveform in an occasion (for convenience, also referred to as a second occasion herein) later than the first occasion. For illustration, some examples are described with reference to FIG. 5.

FIG. 5 illustrates a schematic diagram 500 illustrating an example PHR reporting for an unused waveform according to embodiments of the present disclosure. As shown in FIG. 5, DCI 510 indicates transmission of a PHR for an unused waveform, and the DCI 510 schedules a PUSCH 521. In an example, the PHR for the unused waveform may be carried by the PUSCH 521 scheduled by the DCI 510.

In another example, the PHR for the unused waveform may be carried by the next PUSCH 522. In other words, the PHR for the unused waveform may be carried by the earliest transmission occasion for the PHR not earlier than the PUSCH 521 scheduled by the DCI 510. The earliest transmission occasion may be triggered by an event, for example, a timer expires. In this case, the term “unused waveform” may be a waveform which is not used by the PUSCH 521 scheduled by the DCI 510 triggering the PHR reporting, or may be a waveform which is not used by the PUSCH 522 in which the terminal device 110 reports the PHR. It is to be noted that this is merely an example, any other suitable ways are also feasible.

In this way, a terminal device may only report a PHR for an unused waveform when necessary, and thus signaling overhead may be saved.

### Example Implementation of Methods

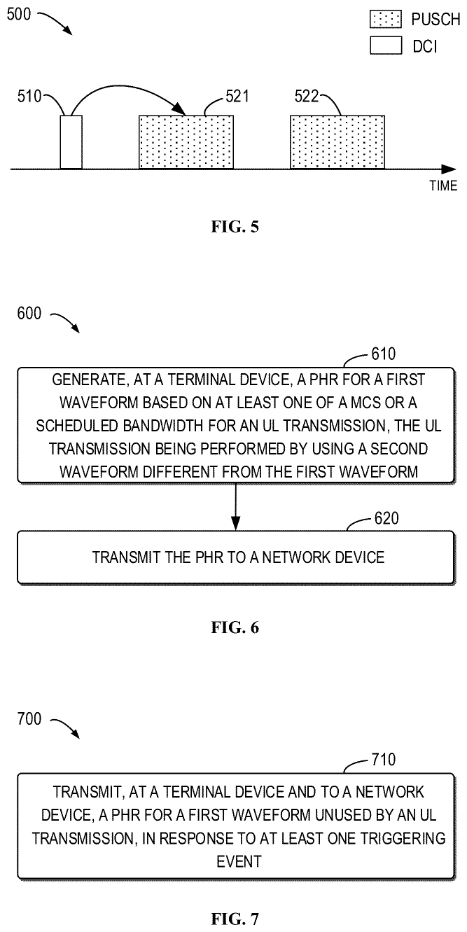

Accordingly, embodiments of the present disclosure provide methods of communication implemented at a terminal device and a network device. These methods will be described below with reference to FIGS. 6 to 7.

FIG. 6 illustrates an example method 600 of communication implemented at a terminal device in accordance with some embodiments of the present disclosure. For example, the method 600 may be performed at the terminal device 110 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, the terminal device 110 generates a PHR for a first waveform based on at least one of a MCS or a scheduled bandwidth for an UL transmission, the UL transmission being performed by using a second waveform different from the first waveform.

In some embodiments, the terminal device 110 may determine a first MCS index in a first MCS table for the first waveform based on a second MCS index in a second MCS table for the second waveform, wherein the second MCS index is used by the UL transmission, and determine a first modulation order for the first waveform and a second modulation order for the second waveform based on the first MCS index and the second MCS index. Then the terminal device 110 may determine the PHR based on the first modulation order and the second modulation order.

In some embodiments, the terminal device 110 may determine the first MCS index as being equal to the second MCS index. In these embodiments, if the first modulation order is the same as the second modulation order, the terminal device 110 may determine the PHR based on the first modulation order or the second modulation order. If the first modulation order is different from the second modulation order, the terminal device 110 may determine the PHR by using a predetermined modulation order based on a type of the second waveform and a type of the second modulation order.

In some embodiments, the terminal device 110 may determine the first MCS index so that a first spectral efficiency associated with the first MCS index is the closest spectral efficiency in the first MCS table to a second spectral efficiency associated with the second MCS index. In these embodiments, if the first modulation order is the same as the second modulation order, the terminal device 110 may determine the PHR based on the first modulation order or the second modulation order. If the first modulation order is different from the second modulation order, the terminal device 110 may determine the PHR by at least one of the following: determining the PHR based on the first modulation order; determining the PHR based on a lower or higher one of the first and second modulation orders; or determining the PHR based on a configuration from the network device 120, the configuration indicating whether the first or second modulation order is used for the determination of the PHR.

In some embodiments, the terminal device 110 may determine a first modulation order for the first waveform as being equal to a second modulation order associated with a second MCS index in a second MCS table for the second waveform; and determine the PHR based on the first modulation order.

In some embodiments, the terminal device 110 may determine a first set of PRBs for the first waveform at least based on a second set of PRBs for the second waveform, and determine the PHR based on the number of PRBs in the first set of PRBs. In some embodiments, the terminal device 110 may determine the first set of PRBs so that the number of PRBs in the first set of PRBs is an integer which is closest to the number of PRBs in the second set of PRBs and the integer is equal to 2^{a2}*3^{a3}*5^{a5}, where a2, a3 and a5 are non-negative integers.

In some embodiments, the terminal device 110 may determine the first set of PRBs so that the first set of PRBs is contiguous and a first PRB in the first set of PRBs is the same as a second PRB in the second set of PRBs. In some embodiments, the terminal device 110 may determine the first set of PRBs so that the first set of PRBs is contiguous and a third PRB in the first set of PRBs is the same as a fourth PRB in a predetermined BWP. In some embodiments, the terminal device 110 may determine the first set of PRBs so that the first set of PRBs is the maximum allowed number of contiguous PRBs.

In some embodiments, if the second set of PRBs is contiguous, the terminal de vice 110 may use the second set of PRBs as the first set of PRBs.

At block 620, the terminal device 110 transmits the PHR to the network device 120. In some embodiments, the terminal device 110 may transmit the PHR together with a further PHR for the second waveform in a MAC CE. In some embodiments, the MAC CE comprises a first indication indicating whether a MPE or a delta value is reported, wherein the delta value is determined based on a difference between the PHR for the first waveform and the further PHR for the second waveform.

In some embodiments, the terminal device 110 may transmit the PHR in a MAC CE, the MAC CE comprising a second indication indicating whether the PHR is based on the first waveform or the second waveform.

With the method of FIG. 6, a PHR reporting for an unused waveform may be clearly defined.

FIG. 7 illustrates another example method 700 of communication implemented at a terminal device in accordance with some embodiments of the present disclosure. For example, the method 700 may be performed at the terminal device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the terminal device 110 transmits, to the network device 120, a PHR for a first waveform unused by an UL transmission, in response to at least one of the following: receiving, from the network device 120, first DCI indicating the transmission of the PHR; a delta value being above or below a threshold delta, wherein the delta value is determined based on a difference between the PHR for the first waveform and a further PHR for a second waveform used by the UL transmission; a value of a PHR being above or below a threshold value; a measured RI changing from a first number to a second number; or a modulation order indicated by second DCI being different from a modulation order indicated by third DCI earlier than the second DCI.

In some embodiments, a field in the first DCI may indicate whether the PHR is reported for the first waveform, the second waveform, or both of the first and second waveforms, and the field comprises at least one of a PHR request field, a SRS request field, or a TPC command field.

In some embodiments, the terminal device 110 may transmit the PHR with the UL transmission in a first occasion, or transmit the PHR in a second occasion later than the first occasion.

In some embodiments, the UL transmission is scheduled by the first DCI. In some embodiments, the PHR is carried by the UL transmission.

With the method of FIG. 7, a PHR for an unused waveform may be reported as needed, and signaling overhead may be saved.

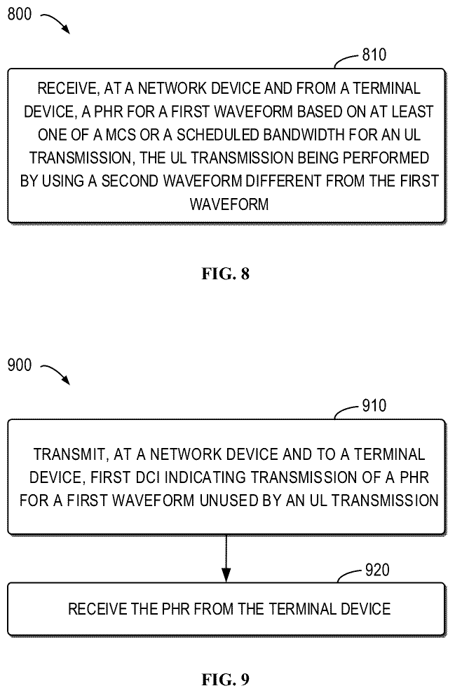

FIG. 8 illustrates an example method 800 of communication implemented at a network device in accordance with some embodiments of the present disclosure. For example, the method 800 may be performed at the network device 120 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the network device 120 receives, from the terminal device 110, a PHR for a first waveform, the PHR being generated by the terminal device 110 based on at least one of a MCS or a scheduled bandwidth for an UL transmission, the UL transmission being performed by using a second waveform different from the first waveform.

In some embodiments, the network device 120 may receive the PHR together with a further PHR for the second waveform in a MAC CE. In some embodiments, the MAC CE may comprise a first indication indicating whether a MPE or a delta value is reported, wherein the delta value is determined based on a difference between the PHR for the first waveform and the further PHR for the second waveform.

In some embodiments, the network device 120 may receive the PHR in a MAC CE, the MAC CE comprising a second indication indicating whether the PHR is based on the first waveform or the second waveform.

With the method of FIG. 8, a network device may obtain power headroom for two different waveforms, and thereby determine whether to perform a waveform switching based on the power headroom for the two different waveforms. Once the network device decides to perform the waveform switching, with the knowledge of PHR for the unused waveform, the network device may determine the number of scheduled PRBs and MCS for the next UL transmission more accurately.

FIG. 9 illustrates another example method 900 of communication implemented at a network device in accordance with some embodiments of the present disclosure. For example, the method 900 may be performed at the network device 120 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the network device 120 transmits, to the terminal device 110, first DCI indicating transmission of a PHR for a first waveform unused by an UL transmission. In some embodiments, a field in the first DCI may indicate whether the PHR is reported for the first waveform, a second waveform used by the UL transmission, or both of the first and second waveforms. In some embodiments, the field may comprise at least one of a PHR request field, a SRS request field, or a TPC command field.

At block 920, the network device 120 receives the PHR from the terminal device 110. In some embodiments, the network device 120 may receive the PHR with the UL transmission in a first occasion, or receive the PHR in a second occasion later than the first occasion.

In some embodiments, the UL transmission is scheduled by the first DCI. In some embodiments, the PHR is carried by the UL transmission.

With the method of FIG. 9, a PHR reporting for an unused waveform may be triggered as needed and signaling overhead may be reduced accordingly.

### Example Implementation of Device and Apparatus

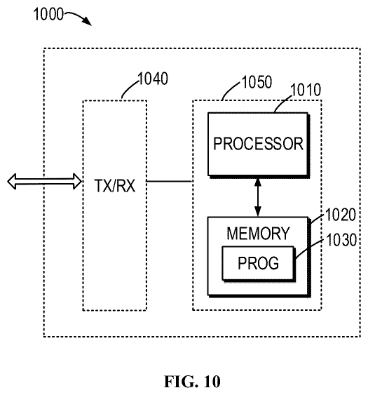

FIG. 10 is a simplified block diagram of a device 1000 that is suitable for implementing embodiments of the present disclosure. The device 1000 can be considered as a further example implementation of the terminal device 110 or the network device 120 as shown in FIG. 1. Accordingly, the device 1000 can be implemented at or as at least a part of the terminal device 110 or the network device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, SI/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises circuitry configured to: generate, at a terminal device, a PHR for a first waveform based on at least one of a MCS or a scheduled bandwidth for an uplink transmission, the uplink transmission being performed by using a second waveform different from the first waveform; and transmit the PHR to a network device.

In some embodiments, the circuitry may be configured to generate the PHR by: determining a first MCS index in a first MCS table for the first waveform based on a second MCS index in a second MCS table for the second waveform, wherein the second MCS index is used by the uplink transmission; determining a first modulation order for the first waveform and a second modulation order for the second waveform based on the first MCS index and the second MCS index; and determining the PHR based on the first modulation order and the second modulation order.

In some embodiments, the circuitry may be configured to determine the first MCS index by determining the first MCS index as being equal to the second MCS index. In some embodiments, the circuitry may be configured to determine the PHR by: in accordance with a determination that the first modulation order is the same as the second modulation order, determining the PHR based on the first modulation order or the second modulation order; or in accordance with a determination that the first modulation order is different from the second modulation order, determining the PHR by using a predetermined modulation order based on a type of the second waveform and a type of the second modulation order.

In some embodiments, the circuitry may be configured to determine the first MCS index by determining the first MCS index so that a first spectral efficiency associated with the first MCS index is the closest spectral efficiency in the first MCS table to a second spectral efficiency associated with the second MCS index.

In some embodiments, the circuitry may be configured to determine the PHR by: in accordance with a determination that the first modulation order is the same as the second modulation order, determining the PHR based on the first modulation order or the second modulation order; or in accordance with a determination that the first modulation order is different from the second modulation order, determining the PHR by at least one of the following: determining the PHR based on the first modulation order; determining the PHR based on a lower or higher one of the first and second modulation orders; or determining the PHR based on a configuration from the network device, the configuration indicating whether the first or second modulation order is used for the determination of the PHR.

In some embodiments, the circuitry may be configured to generate the PHR by: determining a first modulation order for the first waveform as being equal to a second modulation order associated with a second MCS index in a second MCS table for the second waveform; and determining the PHR based on the first modulation order.

In some embodiments, the circuitry may be configured to generate the PHR by: determining a first set of physical resource blocks, PRBs, for the first waveform at least based on a second set of PRBs for the second waveform; and determining the PHR based on the number of PRBs in the first set of PRBs.

In some embodiments, the circuitry may be configured to determine the first set of PRBs by determining the first set of PRBs so that the number of PRBs in the first set of PRBs is an integer which is closest to the number of PRBs in the second set of PRBs and the integer is equal to 2a2*3a3*5a5, where a2, a3 and a5 are non-negative integers.

In some embodiments, the circuitry may be configured to determine the first set of PRBs by at least one of the following: determining the first set of PRBs so that the first set of PRBs is contiguous and a first PRB in the first set of PRBs is the same as a second PRB in the second set of PRBs; determining the first set of PRBs so that the first set of PRBs is contiguous and a third PRB in the first set of PRBs is the same as a fourth PRB in a predetermined bandwidth part, BWP; or determining the first set of PRBs so that the first set of PRBs is the maximum allowed number of contiguous PRBs.

In some embodiments, the circuitry may be configured to determine the first set of PRBs by: in accordance with a determination that the second set of PRBs is contiguous, using the second set of PRBs as the first set of PRBs.

In some embodiments, the circuitry may be configured to transmit the PHR by transmitting the PHR together with a further PHR for the second waveform in a MAC CE. In some embodiments, the MAC CE comprises a first indication indicating whether a MPE or a delta value is reported, wherein the delta value is determined based on a difference between the PHR for the first waveform and the further PHR for the second waveform.

In some embodiments, the circuitry may be configured to transmit the PHR by: transmitting the PHR in a MAC CE, the MAC CE comprising a second indication indicating whether the PHR is based on the first waveform or the second waveform.

In some embodiments, a terminal device comprises a circuitry configured to: transmit, to a network device, a PHR for a first waveform unused by an uplink transmission, in response to at least one of the following: receiving, from the network device, first DCI indicating the transmission of the PHR; a delta value being above or below a threshold delta, wherein the delta value is determined based on a difference between the PHR for the first waveform and a further PHR for a second waveform used by the uplink transmission; a value of the PHR being above or below a threshold value; a measured RI changing from a first number to a second number; or a modulation order indicated by second DCI being different from a modulation order indicated by third DCI earlier than the second DCI.

In some embodiments, a field in the first DCI indicates whether the PHR is reported for the first waveform, the second waveform, or both of the first and second waveforms, and the field comprises at least one of a PHR request field, a SRS request field, or a TPC command field.

In some embodiments, the circuitry may be configured to transmit the PHR by: transmitting the PHR with the uplink transmission in a first occasion; or transmitting the PHR in a second occasion later than the first occasion.

In some embodiments, the uplink transmission is scheduled by the first DCI. In some embodiments, the PHR is carried by the uplink transmission.

In some embodiments, a network device comprises a circuitry configured to: receive, from a terminal device, a PHR for a first waveform, the PHR being generated by the terminal device based on at least one of a MCS or a scheduled bandwidth for an uplink transmission, the uplink transmission being performed by using a second waveform different from the first waveform.

In some embodiments, the circuitry may be configured to receive the PHR by receiving the PHR together with a further PHR for the second waveform in a MAC CE. In some embodiments, the MAC CE comprises a first indication indicating whether a MPE or a delta value is reported, wherein the delta value is determined based on a difference between the PHR for the first waveform and the further PHR for the second waveform.

In some embodiments, the circuitry may be configured to receive the PHR by receiving the PHR in a MAC CE, the MAC CE comprising a second indication indicating whether the PHR is based on the first waveform or the second waveform.

In some embodiments, a network device comprises a circuitry configured to: transmit, to a terminal device, first DCI indicating transmission of a power headroom report, PHR, for a first waveform unused by an uplink transmission; and receive the PHR from the terminal device.

In some embodiments, a field in the first DCI indicates whether the PHR is reported for the first waveform, a second waveform used by the uplink transmission, or both of the first and second waveforms, and the field comprises at least one of a PHR request field, a SRS request field, or a TPC command field.

In some embodiments, the circuitry may be configured to receive the PHR by: receiving the PHR with the uplink transmission in a first occasion; or receiving the PHR in a second occasion later than the first occasion.

In some embodiments, the uplink transmission is scheduled by the first DCI. In some embodiments, the PHR is carried by the uplink transmission.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-30. (canceled)

31. A method comprising:
configuring, at a terminal device, maximum output power for a first waveform based on a modulation and coding scheme, MCS, for an uplink transmission,
the uplink transmission being performed by using a second waveform different from the first waveform; and
transmitting the maximum output power to a network device.
